(19) United States
(12) Patent Application Publication
(10) Pub. No.: US 2025/0129537 A1
(43) Pub. Date: Apr. 24, 2025

(54) DETERGENT DISPENSER FOR A WASHING MACHINE AND WASHING MACHINE

(71) Applicant: E.G.O. Elektro-Gerätebau GmbH, Oberderdingen (DE)

(72) Inventors: Mirja Vogt, Wolfschlugen (DE); Uwe Schaumann, Oberderdingen (DE); Florian Witt, Wentorf (DE); Matthias Hecker, Hamburg (DE)

(21) Appl. No.: 18/882,977

(22) Filed: Sep. 12, 2024

(30) Foreign Application Priority Data
Oct. 20, 2023 (DE) 10 2023 128 918.7

(51) Int. Cl. D06F 39/02; B33Y 10/00; D06F 33/37

(52) U.S. Cl. CPC D06F 39/028; B33Y 10/00; D06F 33/37

(57) ABSTRACT

A detergent dispenser for a washing machine, in which laundry detergents and additives are mixed with water and conveyed onward into a drum of the washing machine, has a receptacle with a plurality of receiving chambers as a pull-out drawer. A first receiving chamber has a chamber outlet at the bottom and is open at the top, wherein the other receiving chambers are closed at the bottom and open at the top. A planar dispenser cover is arranged above the receptacle and has an internal volume with water channels separate from one another therein. A plurality of water channels are routed to a lateral outer side of the dispenser cover where they form channel openings, wherein a plurality of water channels are brought together in the dispenser cover. A water drain channel has an outlet opening above the first receiving chamber. Metering pumps are arranged at the channel openings on the lateral outer side. A water supply channel leads from this channel opening to a receiving chamber closed at the bottom, wherein the water drain channel in the dispenser cover leads from a channel opening to the metering pump into the first receiving chamber.

### CROSS-REFERENCE TO RELATED APPLICATIONS

This application claims priority to German Application No. 10 2023 128 918.7, Oct. 20, 2023, the contents of which are hereby incorporated herein in its entirety by reference.

### FIELD OF APPLICATION AND PRIOR ART

The invention relates to a washing machine detergent dispenser with which detergents and/or additives are mixed with water, after which they are intended to be conveyed onward into a washing machine drum in which the laundry to be washed is located. The invention furthermore relates to a washing machine with such a detergent dispenser.

In conventional washing machines, detergents and optionally rinse conditioners or other additives are placed in a type of drawer or drawer system. Water flowing in from above flushes detergents and additives downward into a funnel-like collecting device. From there, they pass into the interior of the drum or a drum-receiving container and are mixed with water to wash the laundry in the drum.

It is known from DE 10 2014 115 957 A1 to automatically dispense detergents and other additives depending on a washing program selected by an operator. The detergent and additives can be kept in tanks or cartridges or the like that can be replaced as required, in particular when they are empty.

### OBJECT AND SOLUTION

The object of the present invention is to provide an above-stated detergent dispenser and an above-stated washing machine which are capable of solving prior art problems and with which it is preferably possible to construct such a detergent dispenser or a washing machine provided therewith in a simple and practicable manner and to achieve advantageous use, in particular with regard to the use or apportioning of detergents or additives.

This object is achieved by a detergent dispenser having the features of claim 1 and by a washing machine having the features of claim 23. Advantageous and preferred embodiments of the invention are the subject matter of further claims and are explained in greater detail below, some features being described only for the detergent dispenser or only for the washing machine provided therewith. Regardless of this, however, they are intended to be applicable separately and mutually independently both to a detergent dispenser and to a washing machine. The wording of the claims is incorporated into the content of the description by express reference.

The detergent dispenser with the above-stated use has a receptacle that has a plurality of receiving chambers, for example two to five receiving chambers. This receptacle can advantageously be configured as a pull-out drawer in the washing machine, in particular on the front of the washing machine. It can thus advantageously be positioned in a conventional location for a known drawer for adding detergent, for example at the top left on the front of a washing machine. At least one first receiving chamber of the receptacle has a chamber outlet that departs downward or backward therefrom. The chamber outlet is advantageously configured as a simple opening at the bottom, in particular a funnel-shaped bottom, or a rear region or rear wall of the first receiving chamber. The receiving chamber is open at the top, in particular as known from the available prior art. An operator can thus simply introduce, for example, detergent in liquid or powder form into this first receiving chamber from above.

At least one receiving chamber, specifically a receiving chamber other than the first receiving chamber, is closed at the bottom. At the top, it can either be entirely open or have just one opening, possibly also an opening into a pipe connector or hose. There are advantageously a plurality of these receiving chambers and some or all of them are particularly advantageously configured to be of similar or identical size. As will be explained in greater detail below, detergents and/or additives to be automatically apportioned can be placed in these receiving chambers. As is known from the prior art, it is likewise possible to use cartridges for this purpose. While this can increase structural complexity, it has advantages in terms of practical handling.

The detergent dispenser furthermore has a planar dispenser cover that is arranged above the receptacle. It can be arranged thereover at a distance of between 0.5 cm and 5 cm, advantageously of up to 2 cm, i.e., at a relatively small distance. The dispenser cover is substantially flat and has an internal volume or interior with water channels separate from one another therein or has in the interior thereof a plurality of water channels that may extend separately from one another but are at least in part connected to one another. A plurality of such water channels lead to a lateral outer side of the dispenser cover. On exiting therefrom, they form channel openings which can thus be open to the side or point to the side. Instead of the lateral outer side, they can also be routed to a lateral edge region. A plurality of water channels are furthermore brought together in the dispenser cover such that they can individually open into one another or merge into one another. Provision may also be made for more than two water channels to meet at one point. Provision may likewise be made for a plurality of water channels, preferably very short in length, to open one after another into a further water channel, preferably with functional units such as valves or pumps therebetween. At least one water drain channel is provided that has an outlet opening above the first receiving chamber provided with the above-stated chamber outlet. This water drain channel serves to introduce or flush water from above into this first receiving chamber in order to flush out detergent present therein in known manner through the chamber outlet into the drum. The water drain channel can end at this outlet opening but alternatively and advantageously it can also be continued onward.

A metering pump, with which detergents and/or additives are added by volume and so also conveyed or pumped, is arranged at at least one of the channel openings on the lateral outer side or in the lateral edge region. A water supply channel is provided in the dispenser cover that leads from this channel opening to one of the above-described receiving chambers of closed configuration adjacent the first receiving chamber. In particular, the water supply channel has a opening above this receiving chamber or can be routed, for example by way of a pipe connector or an elastic hose, to the receiving chamber or a cartridge or tank located therein with detergent and/or additive therein. The water supply channel is thus ultimately used by the metering pump to draw in detergent or additive therethrough from the corresponding receiving chamber via the channel opening. The metering pump can then pump the drawn-in detergent or additive from the stated channel opening into the water drain channel, from where it is taken to the outlet opening and can so pass into the first receiving chamber or directly into the drum or into a drum-receiving container. The water supply channel is thus connected to the water drain channel or opens into the latter, namely via or through the metering pump. A throttle valve or a controllable valve may here be provided to allow flow through the water drain channel to be controlled or shut off and opened or regulated. This will be further explained below. The water drain channel could alternatively also deliver the detergent or additive to or into the drum via a separate line.

The dispenser cover thus makes it possible to route detergent or additives from tanks or cartridges to the first receiving chamber and from there into the drum-receiving container or directly into the drum. This can have the advantage that a conventional pull-out drawer or in general a receptacle or at least one collecting device arranged below the receptacle or drawer can continue to be configured as previously. Accordingly, a washing machine need only be slightly modified and does not need to be fundamentally redesigned for it to be possible to implement the invention therein. Arranging the at least one metering pump on the dispenser cover itself, which can be permanently installed in the washing machine and is located above the receptacle, in particular facilitates electrical connection to the metering pump since the latter need not be movable with the pull-out receptacle. This simplifies construction and design and reduces potential errors. Because a plurality of water channels are arranged in the dispenser cover, the latter can be manufactured as a single part or as a simply configured module without there being any need to fit a plurality of separate lines or hoses for the water channels. The dispenser cover itself can be manufactured by plastics injection molding, for example in one or two parts, or alternatively by 3D printing. Mass production is thus straightforwardly possible.

A further embodiment of the invention can provide at least one first water inlet from the outside on the dispenser cover, for example as an opening or connection. This water inlet can be connected within the dispenser cover by way of a water channel to the outlet opening via the first receiving chamber. Accordingly, fresh water can for example run directly from the outside into this first receiving chamber as an inlet or infeed into the drum or into a drum-receiving container or tub surrounding the drum. It is possible for this water channel either not to be connected to any other water channel within the dispenser cover or alternatively it can be connected to at least one other water channel within the dispenser cover that leads to the at least one above-stated metering pump. Accordingly, fresh water can also either reach the metering pump itself or at least be passed around the latter, in particular to flush away any residues of detergent or additives there.

One further development of the invention can provide a second water inlet on the detergent dispenser which, under certain circumstances, may also be the only water inlet. It can lead within the dispenser cover to a water channel that is connected to the at least one metering pump, as explained above. This water channel is advantageously connected to all the metering pumps on the dispenser cover, wherein the pump outlet of each metering pump leads to this water channel or is connected thereto. This water channel can accordingly carry along the detergent or additives provided by the metering pumps by way of water flowing therethrough and deliver them into the drum. A circulating pump or other pump can optionally be provided here to repeatedly circulate the water with detergent or additives in the detergent dispenser to ensure effective intermixing. Such a pump can advantageously be arranged directly on the detergent dispenser.

In one advantageous further development of the above-stated invention, the second water inlet with a valve can be connected to a valve or lead to a valve that conveys water onward from the second water inlet in the dispenser cover. This valve can accordingly determine whether or not water at the second water inlet flows into the dispenser cover, in particular into the above-stated water channel and past the metering pump.

An above-stated valve on the second water inlet can preferably be configured as a two-way valve. It is possible for a valve inlet to be connected to the second water inlet or for the second water inlet to lead to the valve inlet. A valve outlet is connected to the water supply channel, such that for example fresh water can be pumped through the metering pump to clean it.

In one possible further development of the invention, the water drain channel can lead from the at least one metering pump, advantageously from all the metering pumps, to the outlet opening in a repeatedly winding course. This repeatedly winding course causes the water flowing along it to swirl more strongly and so dissolve and disperse the entrained detergent or additives more effectively. Furthermore, a greater length of the water drain channel for a given size of dispenser cover can be achieved as a result. One advantageous embodiment of such a water drain channel is a meandering course, wherein the water drain channel may have a plurality of parallel, directly adjoining channel portions that are connected to one another by 180° bends. An alternative embodiment might be a round or approximately polygonal spiral course with the outlet opening in the center. However, the above-stated option of the water drain channel being continued onward after the outlet opening is then no longer available, or at least not in the same plane as the other channel portions. This would make the design considerably more complex. Due to the frequent changes in direction, the meandering course also ensures better mixing of water and additives.

A further development of the invention can provide that the water drain channel has different channel cross-sections. It can accordingly be provided that it has a greater channel cross-section in the region of the repeatedly winding course than along a canal portion that passes by at least one or a plurality of or all of the metering pumps and the pump outlets thereof. For example, different channel cross-sections can accordingly influence the flow velocity of the water and possibly also the swirling thereof. The channel cross-section in the region of the repeatedly winding course is preferably greater than in the channel portion along the at least one metering pump. The channel cross-section may for example be twice to twenty times greater and in particular five times to fifteen times greater. This can ensure that the water flows past the metering pump very quickly and thus carries detergent or additives away very effectively and possibly also somewhat cleans a pump outlet. In the region of the repeatedly winding course, on the other hand, the water flows more slowly but with good swirling due to the multiple bends in order to effectively mix in and dissolve the detergent and additives.

In a further embodiment of the invention, as in the above-stated option, the water drain channel can run onward or be continued onward downstream of the outlet opening, possibly with an identical or constant channel cross-section. The water drain channel can run to a connection with a pump inlet of a circulating pump, wherein such a circulating pump serves to pump water along the water drain channel, in particular in a circuit, if said water drain channel forms such a circuit. A pump outlet of the circulating pump merges into a water channel that leads to a pump outlet of the at least one metering pump, so possibly forming a supply channel. Downstream of the metering pump or the pump outlet thereof, the channel then extends onward as a water drain channel. The pump outlet of the metering pump, in particular all the pump outlets of all the metering pumps, thus opens/open into the water drain channel. This can in particular be in the above-stated channel portion with a smaller channel cross-section, in particular a very much smaller channel cross-section. This circulating pump is capable of pumping water, which is not fresh water, in a circuit in the dispenser cover and thus either repeatedly introducing detergent or additives therein, or alternatively mixing the latter as effectively as possible with the recirculated water before they pass without leaving any residue through the outlet opening into the first receiving chamber and from there into the drum or into the drum-receiving container.

An advantageous embodiment of the invention provides a plurality of metering pumps, in particular two to five metering pumps. These can particularly advantageously be arranged adjacent one another, in particular on the dispenser cover, wherein they can also be fastened or fitted to the dispenser cover. They are preferably fastened to the lateral outer side, but in any event to the channel openings of the water supply channels, i.e., to the ends thereof. A pump inlet of each metering pump is accordingly connected to a water supply channel at the above-stated channel opening. A pump outlet of each metering pump opens into the water drain channel, advantageously into a specific channel portion that particularly advantageously has the above-stated smaller channel cross-section. A short line or short channel therebetween can be provided here.

Similarly to how the metering pumps are preferably provided adjacent one another a certain distance, for example 2 cm to 5 cm, apart, the pump outlets of the metering pumps along the water drain channel should open one after another thereinto. They too should advantageously be the same distance apart. Uniform and advantageous dispensing is accordingly possible.

A further advantage of the metering pumps being fastened or fitted to the dispenser cover in such a way that they protrude laterally is that the structural height of the dispenser cover can be kept lower. In particular, an above-stated receptacle can then be arranged with sufficient space below the dispenser cover.

In one possible embodiment of the invention, the other receiving chambers of the receptacle that are not the first receiving chamber can simply be open at the top. In particular, they can be open at the top over a substantial part of their base area or over their entire base area. It is accordingly straightforwardly possible to introduce or insert a closed container such as a tank or a cartridge with detergent or additive therein into the receiving chambers. Such a container should then have connecting means to the stated water supply channel that leads to the metering pump. Such connecting means can for example be a stated flexible hose or alternatively telescopic lines with a plurality of solid line portions inserted into one another. One option is a plug-in insert with hoses on the lower part of the detergent dispenser.

Provision is advantageously made for the dispenser cover to be of closed construction apart from the above-stated connections for pumps or metering pumps and a possible circulating pump, the stated water connections from the outside that lead into the dispenser cover, an outlet opening into the first receiving chamber and optionally openings for detergent containers or additive containers in one of the other receiving chambers. Provision may be made for the dispenser cover to have a lower part and an upper part, wherein the stated water channels are advantageously formed in the lower part. Finally, the receptacle is arranged below the dispenser cover such that the outlet opening and connections extend downward into the other receiving chambers. Provision may be made for the upper part to be of relatively simple construction, in particular in the form of a flat plate, which is then placed on the lower part or fastened thereto with snap-fit connections and appropriate seals, or is alternatively also permanently adhesively bonded. In particular, the dispenser cover may be of two-part construction, i.e., consist solely of a lower part and an upper part. The lower part should be fastened to the upper part in sealing manner, in particular the water channels, or at least the water drain channel, can be constructed as an open elongate recess in the lower part. Closure from above by way of the upper part means that such a water channel becomes a closed water channel. This has the advantage of preventing water, detergent or additives from splashing out.

A further advantageous possibility for manufacturing a dispenser cover, which can then in particular also be of one-piece construction, is 3D printing of plastics. Highly advantageous shapes, in particular also of the water channels, in particular closed water channels, can then be manufactured. Leakage problems can consequently easily be avoided. Furthermore, fitting of the detergent dispenser is facilitated.

In a further advantageous embodiment of the invention, at least the interior or the internal volume of the dispenser cover can be constructed without moving parts. This then means that moving parts or functional units such as valves, pumps or the like additionally have to be mounted on the dispenser cover, in particular on an outer side, such that channels corresponding to these functional units are then routed to these functional units. As a result, it may then be possible to avoid relatively significant effort during manufacture of the dispenser cover. Furthermore, in the event of a fault, the externally mounted functional units such as valves or pumps can be more readily repaired or replaced as they are easier to access.

In one possible embodiment of the invention, the detergent dispenser may have a heating means for the dispenser cover, wherein the heating means is in particular provided or arranged on the dispenser cover. In this way, it is intended to be possible to heat or warm up flowing water, detergents and/or the stated additives within the dispenser cover. The purpose of this is less to heat water to relatively high temperatures such as 60° C. up to 90° C. for corresponding washing cycles in the washing machine. Instead, the intention is advantageously to warm up the detergent or above all the additives themselves in order to increase or maximize their effectiveness. For instance, some enzymes have a particularly good action at temperatures that are above room temperature or above the temperature of incoming fresh water. Alternatively, viscosity can be modified by heating, or detergents or additives can become more fluid at higher temperatures, which improves the use thereof. Warming to temperatures of 30° C. to 40° C. may be sufficient here. A heating means can for this purpose also be arranged locally in the vicinity of the additives or their water supply channels.

Such a heating means can in principle be configured in many and varied ways. One preferred option is an induction heating coil that is in particular arranged on the top of the dispenser cover and covers at least part, in particular between 50% and 90%, of the area of the top of the dispenser cover. In particular, it should be arranged in the region of the above-stated water drain channel, for example also directly where metering pumps introduce detergent and/or additives into the water drain channel by way of the water supply channel. Inductively heatable material can then be arranged within the dispenser cover, advantageously as close as possible to the water channels. This can be provided in the form of inductively heatable metal rods or small pieces of metal, or alternatively metal mesh or metal powder. In particular, this inductively heatable material can be arranged in an above-stated lower part of the dispenser cover, i.e., as close as possible to the water channels. It could alternatively also be provided, possibly also additionally, on the upper part, which is also in direct contact with the lower part and the water channels.

A washing machine according to the invention thus has a previously described detergent dispenser, and a housing as the outer housing. Within the housing there is a drum-receiving container with the drum therein, which is accessible via a door. The washing machine furthermore has a water routing system and a washing machine controller, wherein the water routing system has water lines and a pump, in particular also filters and a heating means, wherein the heating means may be integrated in the pump. The detergent dispenser can advantageously be arranged in an upper region of the washing machine such that it can be readily accessed by an operator. An upper left-hand region, as is often usual in washing machines, or also an upper right-hand region are suitable. This means that it is possible to utilize the space available in the housing at the top left and top right next to the drum.

A further development of the invention can provide that the washing machine has a collecting device below the detergent dispenser, in particular below a stated chamber outlet from the first receiving chamber of the receptacle. This can be formed in the manner of a funnel. A water line can lead therefrom into the drum-receiving container in order to introduce either fresh water or water combined with detergent and/or additives into the drum-receiving container and thus into the drum and onto laundry present therein.

Provision can advantageously be made for the chamber outlet of the first receiving chamber of the receptacle to be arranged at one end, in particular at the rear end, when viewed in the longitudinal direction. This means that detergent or the like can be introduced from above into the front region, which is readily accessible in the case of a pull-out embodiment of the receptacle in the manner of a drawer.

These and further features are revealed in the description and in the drawings as well as in the claims, wherein the individual features can be realized singly or severally in the form of subcombinations in one embodiment of the invention and in other fields, and can constitute advantageous embodiments eligible for protection in themselves, for which protection is here sought. The subdivision of the application into sub-headings and individual sections does not limit the general validity of statements made therebelow.

### BRIEF DESCRIPTION OF THE DRAWINGS

An exemplary embodiment of the invention is shown in the drawings and is explained in greater detail below. In the drawings:

FIG. 1 shows a schematic functional side view of a washing machine according to the invention with a detergent dispenser according to the invention,

FIG. 2 shows a front view of the washing machine of FIG. 1 depicting the arrangement of the detergent dispenser at the top left on the front of the washing machine,

FIG. 3 shows an oblique view from above of the detergent dispenser according to the invention with channels therein, without the upper part of a dispenser cover,

FIG. 4 is a front view of the detergent dispenser of FIG. 3 indicating the upper part of the dispenser cover and laterally arranged metering pumps,

FIG. 5 is a plan view of the detergent dispenser of FIG. 3 or of the top of the dispenser cover,

FIG. 6 is a bottom view of the dispenser cover of FIG. 5,

FIG. 7 is an oblique representation of the dispenser cover from the back without the drawer therebelow and

FIG. 8 is a bottom view of the dispenser cover in an oblique representation without the drawer therebelow.

### DETAILED DESCRIPTION OF THE EXEMPLARY EMBODIMENTS

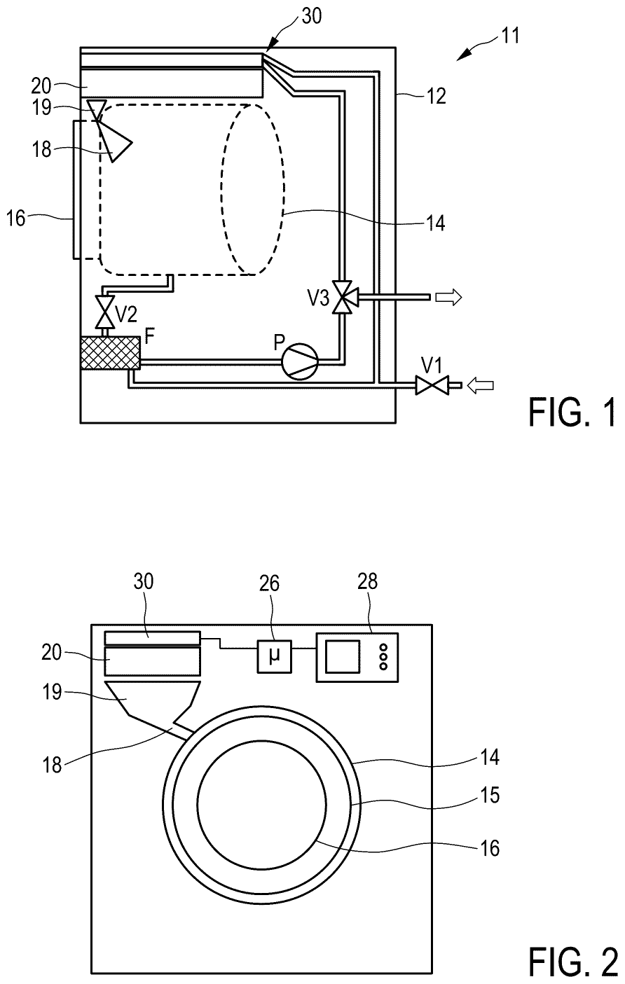

FIG. 1 is a side view, specifically in a substantially functional and simplified form, of a washing machine 11 according to the invention with a housing 12. FIG. 2 shows a front view of this washing machine 11. A drum-receiving container 14 is arranged in the housing 12 with a rotatable drum 15 arranged therein, to which an access door 16 on the front provides access. A water supply 18 projects from above into the drum-receiving container 14, for example configured as a simple water outlet or a spray nozzle. The water comes from a collecting funnel 19 below a drawer 20 which is part of a detergent dispenser 30 according to the invention. This is explained in greater detail below.

A water routing system within the washing machine 11 leads from the drum-receiving container 14 via a valve V2 to a filter F. Water can be introduced into the filter F on the one hand from the outside via a valve V1, wherein this water can also pass directly from valve V1 to the detergent dispenser 30.

Water can pass from filter F to a pump P and onward to a three-way valve V3. On the one hand, water can be pumped out of the washing machine 11 to an outflow. On the other hand, water can be pumped upward to the detergent dispenser 30 and/or drawer 20, for example in a kind of circuit via the drum 15 or drum-receiving container 14.

It is clear from the front view of FIG. 2 how water from the drawer 20 can pass in per se conventional manner into a collecting funnel 19 arranged therebelow and from there via the water supply 18 into the drum-receiving container 14.

It can furthermore be seen that the washing machine 11 has a controller 26. This is connected both to the left with the detergent dispenser 30 and to the right with an operating means 28. This operating means 28 can be configured as known per se from the prior art, advantageously with a display and operating elements as conventional. The controller 26 can above all also control the detergent dispenser 30 or the functional units thereof, which are described below, in particular the metering pumps.

The oblique representation of a detailed embodiment of the detergent dispenser 30, but without the upper part on a lower part 35, shows its interior configuration with water channels in the above-stated internal volume of the dispenser cover 33. The drawing also shows the arrangement of the drawer 20 therebelow and of the metering pumps 67 to 69 on the right-hand outer side together with the circulating pump 70. There can also be different types of metering pumps, for example peristaltic pumps and gear pumps, for example depending on the nature of the additives.

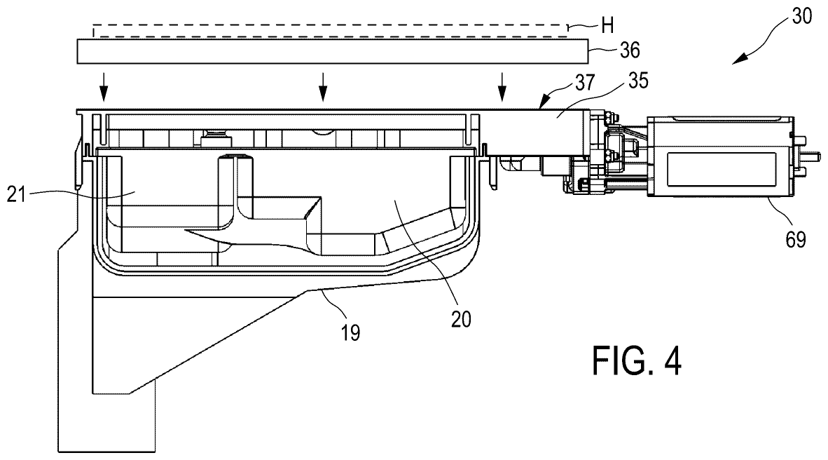

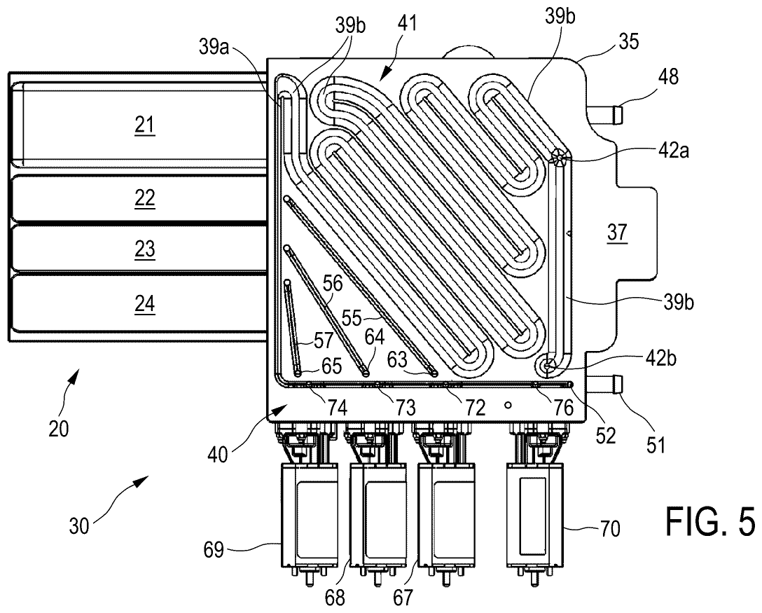

The dispenser cover 33 substantially consists of a lower part 35 with a top 37 which is flat or extends in one plane apart from the water channels formed therein. The front view of FIG. 4 shows that an upper part 36 of the dispenser cover 33 can be placed and fastened, for example adhesively bonded, thereon or on the top 37. This top 37 advantageously takes the form of a thin plate and has a closed and flat surface on its bottom facing the top 37 of the lower part 35. A heating means H with which the dispenser cover 33 and in particular liquid located or moving therein, such as water together with detergent and additives, can be heated is shown in dashed lines on the top of the upper part 36. For this purpose, inductively heatable material, such as metal powder, metal chips or larger metal rods, can be arranged in the material of the lower part 35 of the dispenser cover 33. In this case, the heating means H can be an induction heating coil and have a heating action with a controllable temperature, preferably by using temperature sensors.

On the top 37 of the lower part 35 or in this top 37 itself, a water drain channel 39 is above all provided, specifically as a narrow water drain channel 39a along the side pointing downward to the right and along the side pointing downward to the left. A first region 40 is thus formed here, in particular in the right-hand lower corner region, in which the water drain channel 39a is after all narrow or has a relatively small cross-section. At the left-pointing corner of the lower part 35, the narrow water drain channel 39a merges into the wide water drain channel 39b. With this greater width and also greater depth as well as a much greater overall channel cross-section, it then takes a meandering course in a second region 41. A plurality of straight portions are connected to one another with 180° bends so as to accommodate the greatest possible length with numerous such 180° bends in the stated second region 41. As the plan view of FIG. 5, for example shows, the channel cross-section of the water drain channel 39a in the first region 40 may be about one twentieth of the channel cross-section of the water drain channel 39b in the second region 41.

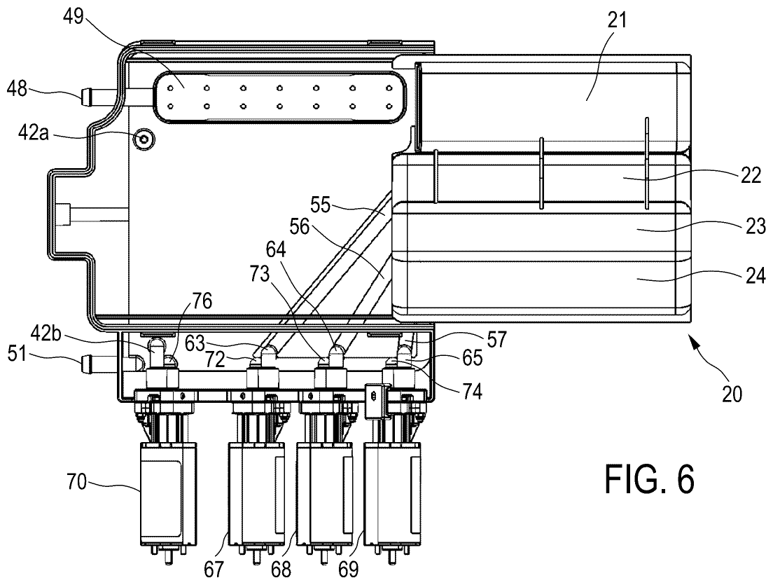

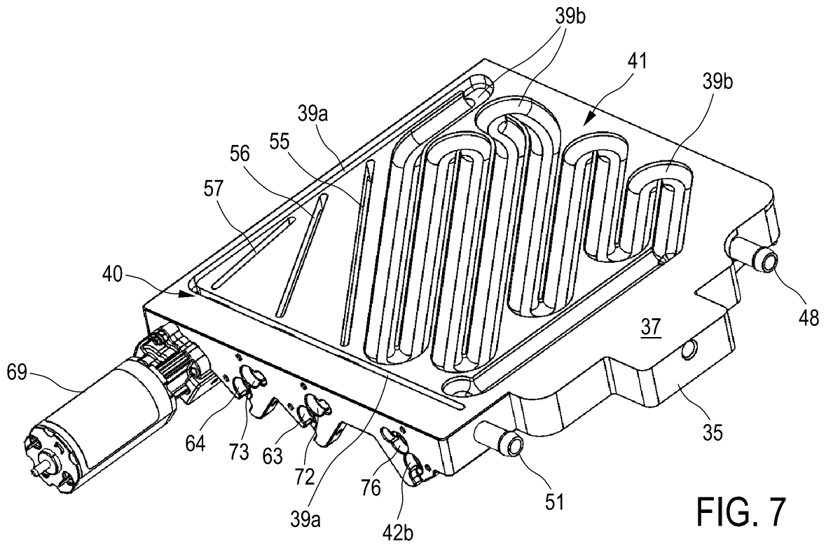

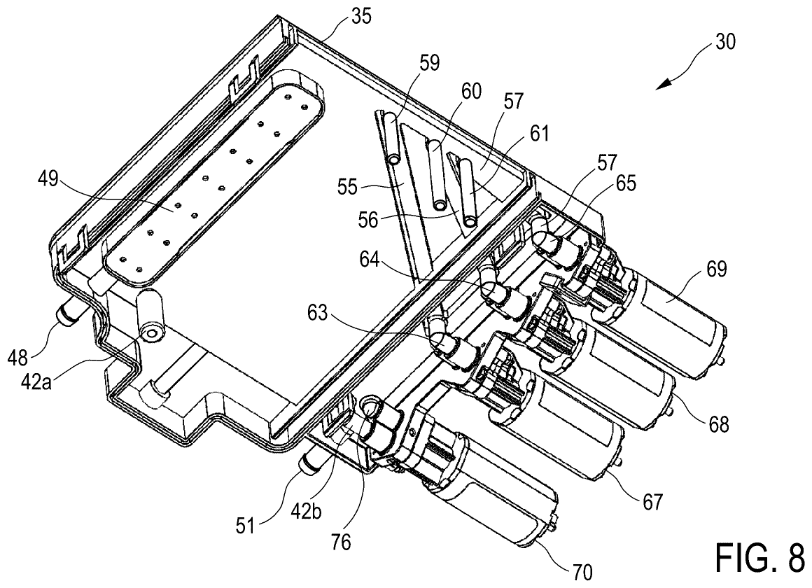

As the plan view of the dispenser cover 33 or of the lower part 35 according to FIG. 5 shows, a downward outlet opening 42a from the water drain channel 39b is provided in the rear left-hand corner region of the second region 41. The bottom view of the dispenser cover 33 according to FIG. 6 shows this outlet opening 42a. However, the water drain channel 39b continues onward past this outlet opening 42a and then ends shortly before upper right-hand beginning of the narrow water drain channel 39a. There is no transition here, but water can exit downward through a further outlet opening 42b. As the bottom view of FIG. 6 again shows, this outlet opening 42b goes toward the lateral outer side with a short pipe bend. This is also shown in the oblique bottom view of FIG. 8. According to the oblique view from above of FIG. 7, the outlet opening 42b goes to an opening on the lateral outer side. The purpose of this is explained in greater detail below.

The plan view of FIGS. 5 and 7 very clearly shows that a major part of the top 37 of the lower part 35 is utilized, above all for arranging therein the water drain channels 39a and 39b with a maximal possible overall length. This maximum length means, for example, that water flowing therein can also be heated by way of the heating means H as shown in FIG. 4. Above all, however, intermixing with the above-stated additives can take place very effectively.

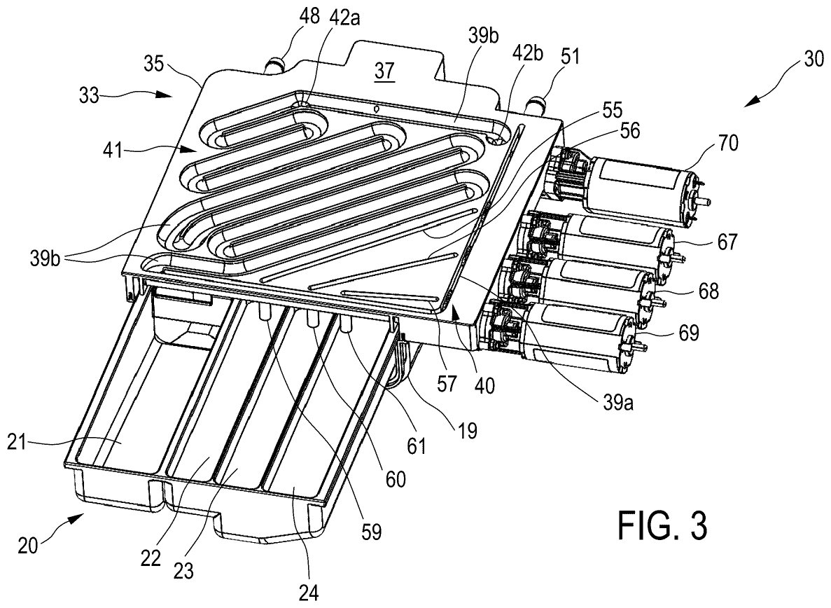

The pull-out drawer 20, which according to FIGS. 3 to 6 is arranged in the detergent dispenser 30 and below the dispenser cover 33, can be configured substantially as known from the prior art. On the far left, the drawer 20 has a first receiving chamber 21 which is the widest and has the largest capacity. It is open at the top and washing powder and other additives can be added manually for a wash cycle. The first receiving chamber 21 can also be open at the bottom or in particular to the rear and bottom, such that incoming water can flush out the detergent. It can accordingly pass according to FIG. 4 into the collecting funnel 19 arranged therebelow and from there according to FIGS. 1 and 2 via the water supply 18 into the drum-receiving container 14.

A second receiving chamber 22, a third receiving chamber 23 and a fourth receiving chamber 24 are arranged adjacent one another to the right beside the first receiving chamber 21. They can differ from one another in width and in particular be narrower than the first receiving chamber. In the exemplary embodiment shown here, the receiving chambers 22 to 24 are open at the top, similarly to the first receiving chamber 21. They can be filled with specific additives that are used only occasionally or depending on the laundry to be washed and the selected washing program. In particular, they are not added manually as in the first receiving chamber 21, but the washing machine itself makes the addition automatically, in particular by way of the controller 26. This has already been thoroughly explained in principle.

At the rear left, a first water inlet 48 is formed as an elongate, protruding connector on the lower part 35. According to the bottom views of FIGS. 6 and 8, water flows into the first water inlet 48, for example fresh water from valve V1 or from pump P and from valve V3 as shown in FIG. 1. It flows in the lower part 35 to the water distributor 49 that has fourteen small downward-pointing openings. These are arranged above the first receiving chamber 21 when the latter is completely pushed in together with the drawer 20. A large volume of fresh water can accordingly flow in and flush detergent out of the first receiving chamber 21 in a manner known per se.

According to FIGS. 3, 5 and 7, three further water channels are provided on the top 37 of the lower part 35, specifically a first water supply channel 55, a second water supply channel 56 and a third water supply channel 57. They are connected on the one hand via downward-pointing openings to intake means 59, 60 and 61 that extend downward into the drawer 20 and are thus immersed in liquid in one of the corresponding receiving chambers. The first intake means 59, which is connected to the first water supply channel 55, extends into the second receiving chamber 22. The second intake means 60, which leads to the second water supply channel 56, extends into the third receiving chamber 23. The third intake means 61, which is connected in water-conducting manner to the third water supply channel 57, extends into the fourth receiving chamber 24. These three water supply channels 55 to 57 extend in different oblique directions and with different lengths in the right-hand lower corner region of the lower part 35 as shown in FIG. 5.

The first water supply channel 55 has a first downward channel opening 63 at its top right end. As shown in FIGS. 6 and 8, this merges, similarly to outlet opening 42b, into a short pipe bend that forms the lateral outer side of the externally accessible first channel opening 63 visible in FIG. 7.

The second water supply channel 56 correspondingly ends at its upper right-hand end in a second channel opening 64. It too leads from the bottom of the lower part 35 in a short tube portion to the lateral outer side, where the second channel opening 64 is formed. The third water supply channel 57 has a third channel opening 65 at its right-hand end. It too leads on the bottom of the lower part 35 to a short pipe bend and to the lateral outer side. FIG. 7 shows a single third metering pump 69. According to FIGS. 3 to 5, there are further such metering pumps. A first metering pump 67 is fitted and connected to or for the first channel opening 63. A second metering pump 68 is provided and arranged at or for the second channel opening 64. These metering pumps 67 to 69 can accordingly draw in additives from receiving chambers 22 to 24 via water supply channels 55 to 57. As the oblique view of the lateral outer side of FIG. 7 shows, metering pump 67, which is not shown here, is connected to the first channel opening 63 by a pump inlet. A pump outlet is connected to the first orifice 72 shown here. This orifice 72 leads via a short pipe bend upward and ends as shown in FIG. 5 as a first orifice 72 in the narrow region of the water drain channel 39a. The additive drawn in from the second receiving chamber 22 by the metering pump 67 and located there can thus be introduced into the narrow region of the water drain channel 39a at the first orifice 72. A second orifice 73 is correspondingly provided for the second metering pump 68 at the second channel opening 64. A third orifice 74 is shown for the third metering pump 69, which is fitted in FIG. 7. Via the three orifices 72 to 74, the additives from receiving chambers 22 to 24 can thus be flushed with water into water drain channel 39a and ultimately into the drum-receiving container 14.

However, so that additives can be conveyed or flushed along the water drain channel 39a, a second water inlet 51 in the form of short pipe connector is provided at the rear right of the lower part 35. As shown in the bottom views of FIGS. 6 and 8, an opening in this second water inlet 51 goes upward with a short pipe bend and opens as an outlet opening 52 into the start of the narrow water drain channel 39a. Water flowing into the second water inlet 51 can thus flow along the entire water drain channel 39a and 39b. Apportioned additives are flushed along and, especially in the second region 41 with the large channel cross-section and correspondingly slow flow and 180° bends, thoroughly intermixed among themselves or with the water and dissolved therein and so dispersed as uniformly as possible therein. Furthermore, very good cleanliness and hygiene can be achieved, especially in the region of the orifices 72 to 74 with water flowing therethrough.

The precise manner in which dispensing is carried out by the metering pumps 67 to 69 at the orifices 72 to 74 is not entirely apparent here. The details are, however, of no relevance, what is important is that the additives can be flushed away effectively leaving as few residues as possible.

The above-stated outlet opening 42b on the lateral outer side of the lower part 35 can lead to a circulating pump 70. The latter can in principle be configured similarly to metering pumps 67 to 69, but can possibly be designed for a higher pumping capacity. In this respect, in need not operate in precisely the same way as metering pumps 67 to 69. The three metering pumps 67, 68 and 69 are advantageously all identical. This means that just one type of metering pump need be used. Similarly, the circulating pump 70 could also be of the same type or have an identical design. The pumps 67 to 70 are advantageously controlled way of the controller 26. It can likewise control the operation of the heating means H.

A pump outlet of the circulating pump 70 is connected to the orifice 76 shown in FIG. 7 which, according to the plan view of FIG. 5, opens into the water drain channel 39a just below the outlet opening 52. Water can thus be pumped, as it were, in a circuit along water drain channels 39a and 39b by way of the circulating pump 70. Given appropriate flow velocities, the volume of water flowing downward through the first outlet opening 42a into the first receiving chamber 21 is not very large. The cross-sections of outlet openings 42a and 42b can be configured accordingly. If the circulating pump 70 is not in operation, outlet opening 42b is as it were closed or water cannot flow out therethrough from the end of the water drain channel 39b. A throttle valve which only opens at a specific limit pressure, or even better a controllable valve could be provided to allow flow downward through the outlet opening 42a and/or 42b to be controlled or shut off and opened or even regulated. There is then no dependency on flow velocities or optionally pressures. A valve can be configured as a simple shut-off valve which is thus simple and robust.

Comparing the views of the dispenser cover 33 or the lower part 35 from above and below reveals that the manufacture thereof, in particular if it is to be in one piece, is highly complex. It is therefore possible to manufacture the lower part 35 by 3D printing. In this way, even the previously described pipe bends on the bottom of the lower part 35 are easily manufactured. Alternatively, they could also be fitted or adhesively bonded to the lower part 35 as separate parts.

Instead of the intake means 59 to 61, which are shown once again in FIG. 8, flexible and possibly also variable-length hoses could be connected to shorter intake means. These hoses could be connected to cartridges or the like that are arranged in one of receiving chambers 22 to 24. They could accordingly be a practical replacement for the stated open receiving chambers with openly arranged additives.

One of the major advantages of the detergent dispenser 30 according to the invention together with the specific dispenser cover 33 is that, although manufacturing it as a single part may be somewhat more complex, subsequent assembly to obtain the complete detergent dispenser 30 is very much simpler. Above all, problems with watertightness can also be avoided. If the upper part 36 according to FIG. 4 is fastened, advantageously adhesively bonded, to the top 37 of the lower part 35, the water drain channels 39a and 39b, which can be seen to be open at the top, are as it were sealed at the top or to the outside.

1. A detergent dispenser for a washing machine for mixing detergents and/or additives into water in said detergent dispenser and conveying them onward into a drum of said washing machine with laundry therein, wherein said detergent dispenser has:
a receptacle, wherein
said receptacle has a plurality of receiving chambers,
at least one first of said receiving chambers has a chamber outlet at a bottom and is open at a top, and
at least one said receiving chamber is closed at a bottom and has an opening at a top,
a planar dispenser cover being arranged above said receptacle, wherein
said dispenser cover has an internal volume with water channels separate from one another therein,
a plurality of said water channels are routed to a lateral outer side of said dispenser cover to form channel openings,
a plurality of said water channels are brought together in said dispenser cover, and
at least one water drain channel is provided having an outlet opening above said first receiving chamber provided with said chamber outlet,
wherein a metering pump is arranged at at least one of said channel openings on said lateral outer side and a water supply channel leads from said channel opening to a receiving chamber closed at a bottom,
wherein said water drain channel in said dispenser cover leads from one said channel opening to said metering pump to said outlet opening into said first receiving chamber.

2. The detergent dispenser as claimed in claim 1, wherein at least one first water inlet from an outside is provided on said dispenser cover, wherein said water inlet is connected within said dispenser cover by way of a water channel to said outlet opening via said first receiving chamber.

3. The detergent dispenser as claimed in claim 2, wherein said water channel is either not connected to any other of said water channels within said dispenser cover or is connected to at least one other said water channel within said dispenser cover that leads to said at least one metering pump.

4. The detergent dispenser as claimed in claim 1, wherein a second water inlet is provided on said detergent dispenser which leads within said dispenser cover to a water channel being connected to said at least one metering pump, wherein said water channel is connected to all said metering pumps on said dispenser cover.

5. The detergent dispenser as claimed in claim 4, wherein said second water inlet is connected to a valve that conveys said water onward from said second water inlet in said dispenser cover.

6. The detergent dispenser as claimed in claim 5, wherein said valve is a two-way valve with a valve inlet and a valve outlet, wherein said valve inlet is connected to said second water inlet and said valve outlet is connected to said water drain channel.

7. The detergent dispenser as claimed in claim 1, wherein said water drain channel leads in a repeatedly winding course from said at least one metering pump to said outlet opening.

8. The detergent dispenser as claimed in claim 7, wherein said water drain channel is configured in a meandering course and has a plurality of parallel, directly adjoining channel portions being connected to one another by 180° bends.

9. The detergent dispenser as claimed in claim 7, wherein, in a region of said repeatedly winding course, said water drain channel has a greater channel cross-section than along a portion passing by at least one said metering pump or by a plurality of said metering pumps.

10. The detergent dispenser as claimed in claim 9, wherein, in a region of said repeatedly winding course, said channel cross-section is twice to twenty times greater than in a portion along said at least one metering pump.

11. The detergent dispenser as claimed in claim 1, wherein said water drain channel runs onward downstream of said outlet opening to a connection with a pump inlet of a circulating pump for pumping water along said water drain channel in a circuit, wherein a pump outlet of said circulating pump goes into a water channel to a pump outlet of said at least one metering pump, wherein said water channel runs onward downstream of said metering pump or said pump outlet thereof as a water drain channel such that said pump outlet of said metering pump opens into said water drain channel.

12. The detergent dispenser as claimed in claim 1, wherein two to five said metering pumps are provided adjacent one another and are arranged on a lateral outer side of said dispenser cover with said channel openings, wherein a pump inlet of said metering pumps is connected to a water supply channel at said connection opening and a pump outlet of said metering pumps opens into said water drain channel.

13. The detergent dispenser as claimed in claim 12, wherein said pump outlets of said metering pumps along said water drain channel open one after another into said water drain channel, wherein said water drain channel has a smaller channel cross-section at said region.

14. The detergent dispenser as claimed in claim 12, wherein said metering pumps are mechanically fastened to said dispenser cover.

15. The detergent dispenser as claimed in claim 1, wherein said receiving chambers other than said first receiving chamber are open at said top for introducing or inserting a closed container with detergent or additive therein, wherein said closed container has connecting means to said water supply channel to said metering pump.

16. The detergent dispenser as claimed in claim 1, wherein said dispenser cover is of closed construction apart from connections for said pumps, water connections from an outside into said dispenser cover, an outlet opening into said first receiving chamber and optionally openings for detergent containers or additive containers in one of said other receiving chambers.

17. The detergent dispenser as claimed in claim 1, wherein said dispenser cover is of two-part construction with a lower part and an upper part.

18. The detergent dispenser as claimed in claim 17, wherein said upper part is constructed as a flat plate and said lower part has all said water channels.

19. The detergent dispenser as claimed in claim 1, wherein said dispenser cover is manufactured as a single integral part by 3D printing.

20. The detergent dispenser as claimed in claim 1, wherein an internal volume of said dispenser cover or said entire dispenser cover is constructed without moving parts.

21. The detergent dispenser as claimed in claim 1, wherein said dispenser cover has a heating means for heating water flowing within said dispenser cover, wherein said heating means has an induction heating coil and wherein inductively heatable material is arranged within said dispenser cover.

22. The detergent dispenser as claimed in claim 21, wherein said inductively heatable material is arranged close to or along at least one of said water channels in an internal volume of said dispenser cover.

23. A washing machine with said detergent dispenser as claimed in claim 1, with a housing, a drum-receiving container in said housing, a drum in said drum-receiving container, a door for said drum, a water routing system and a washing machine controller, wherein said water routing system has water lines and a pump.

24. The washing machine with detergent dispenser as claimed in claim 23, wherein said detergent dispenser is arranged in an upper left-hand region or in an upper right-hand region of said washing machine.

25. The washing machine as claimed in claim 23, wherein a collecting device in a form of a funnel is provided below said detergent dispenser, from which collecting device a water line leads into said drum-receiving container.
